(19) United States
(12) Patent Application Publication
(10) Pub. No.: US 2024/0370282 A1
(43) Pub. Date: Nov. 7, 2024

(54) DATA PROCESSING METHOD, PROGRAMMABLE NETWORK CARD DEVICE, PHYSICAL SERVER, AND STORAGE MEDIUM

(71) Applicant: Hangzhou AliCloud Feitian Information Technology Co., Ltd., Hangzhou City (CN)

(72) Inventors: Yilong LYU, Hangzhou (CN); Chao XU, Hangzhou (CN); Shangwei XIE, Hangzhou (CN); Zikang CHEN, Hangzhou (CN); Shunmin ZHU, Hangzhou (CN)

(21) Appl. No.: 18/685,219

(22) PCT Filed: Sep. 28, 2022
(86) PCT No.: PCT/CN2022/122213

§ 371 Date: Feb. 20, 2024

(30) Foreign Application Priority Data
Nov. 19, 2021 (CN) 202111384031.8

(51) Int. Cl. G06F 9/455; G06F 9/54

(52) U.S. Cl. CPC G06F 9/45533; G06F 9/543

(57) ABSTRACT

Embodiments of the present application provide a data processing method, a programmable network card device, a physical server and a storage medium. In an embodiment of the present application, for a virtual network card of a virtual machine, on the one hand, a network card acceleration module corresponding to the virtual network card is implemented in the programmable network card device based on programmable hardware, and on the other hand, a service interface component used to implement hardware offloading of the virtual network card is provided in the virtual machine for its upper layer application, so that hardware offloading can be performed on functions of the virtual network card of the virtual machine based on the programmable network card device.

### CROSS-REFERENCE TO RELATED APPLICATIONS

This application is a National Stage of International Application No. PCT/CN2022/122213, and filed on Sep. 28, 2022, which claims priority to Chinese Patent Application No. 202111384031.8, filed with the China National Intellectual Property Administration on Nov. 19, 2021 and titled “DATA PROCESSING METHOD, PROGRAMMABLE NETWORK CARD DEVICE, PHYSICAL SERVER, AND STORAGE MEDIUM”. The disclosures of the aforementioned applications are hereby incorporated by reference in their entireties.

### TECHNICAL FIELD

The present application relates to a field of cloud computing and, in particular, to a data processing method, a programmable network card device, a physical server, and a storage medium.

### BACKGROUND

Cloud computing is an Internet-based distributed computing that allows a user to access resources on the “cloud” at any time and use them on demand. In the field of cloud computing, a virtual machine is the most commonly used virtualization technology, which can provide the user with a fully isolated computer operating environment with complete hardware system functionality.

For a virtual machine on the cloud, a virtual network card can be simulated through software or hardware, and a network forwarding function of the virtual machine is achieved through the virtual network card, that is, an application in the virtual machine need to send and receive data through the virtual network card of the virtual machine. Where the operation of the virtual network card needs to occupy the CPU and memory of the virtual machine, which will affect the performance of the virtual machine, in addition, the performance of network forwarding implemented based on software is poor.

### SUMMARY

Various aspects of the present application provide a data processing method, a programmable network card device, a physical server, and a storage medium, for improving network forwarding performance of a virtual machine.

An embodiment of the present application provides a physical server, including: a physical machine, where the physical machine is deployed in the physical machine, and the virtual machine has a virtual network card configured to provide a data transmission service for an upper layer application in the virtual machine; the physical machine server further includes a programmable network card device, in which a virtual switch is implemented for data forwarding between different virtual machines; where the programmable network card device further includes a network card acceleration module implemented based on programmable hardware, and the virtual machine is further configured to provide a first service interface component for implementing hardware offloading of the virtual network card to the upper layer application of the virtual machine, for the upper layer application to configure, through the first service interface component and the virtual switch, a first forwarding flow table used for the virtual network card into the network card acceleration module; and the network card acceleration module is configured to provide a data transmission acceleration service for the virtual network card based on the first forwarding flow table.

An embodiment of the present application further provides a programmable network card device, where the programmable network card device includes: a network card acceleration module implemented based on programmable hardware, the network card acceleration module corresponds to one virtual network card; and the network card acceleration module is configured with a first forwarding flow table used by the virtual network card, and configured to provide a data transmission acceleration service for the virtual network card based on the first forwarding flow table.

An embodiment of the present application further provides a data processing method, applied to a physical server, where the physical server includes a physical machine, a virtual machine is deployed in the physical machine, and the virtual machine has a virtual network card, the physical server further includes a programmable network card device, the programmable network card device includes a network card acceleration module implemented based on programmable hardware, and a virtual switch configured to perform data forwarding between different virtual machines, and the method includes: receiving, by a first service interface component, a call request initiated by an upper layer application in the virtual machine, where the call request includes a first forwarding flow table used for the virtual network card, and configuring the first forwarding flow table into the network card acceleration module through the virtual switch, for the network card acceleration module to provide a data transmission acceleration service for the virtual network card based on the first forwarding flow table; where the first service interface component is a service interface provided by the virtual machine to an upper layer application of the virtual machine and used to implement hardware offloading of the virtual network card.

An embodiment of the present application further provides a computer readable storage medium storing a computer program, where the computer program, when executed by a processor, causes the processor to implement steps in the data processing method provided by an embodiment of the present application.

An embodiment of the present application further provides a computer program product including a computer program/instructions, where the computer program/the instructions are, when executed by a processor, cause the processor to implement steps in the data processing method provided by an embodiment of the present application.

In an embodiment of the present application, for a virtual network card of a virtual machine, on the one hand, a network card acceleration module corresponding to the virtual network card is implemented in the programmable network card device based on programmable hardware, and on the other hand, a service interface component used to implement hardware offloading of the virtual network card is provided in the virtual machine for its upper layer application, so that hardware offloading can be performed on functions of the virtual network card of the virtual machine based on the programmable network card device. Specifically, the upper layer application in the virtual machine configures a forwarding flow table used for the virtual network card into the network card acceleration module through the service interface component, the subsequent data transmission process may be completed by the network card acceleration module based on the forwarding flow table, without or reducing the participation of the virtual network card, which may save CPU resources of the virtual machine, moreover, the data transmission based on hardware may also improve data transmission performance compared to a data transmission method based software.

### BRIEF DESCRIPTION OF DRAWINGS

The accompanying drawings illustrated herein are used to provide a further understanding of the present application and form part of the present application, and the schematic embodiments of the present application and the description thereof are used for the purpose of explaining the present application and do not constitute an improper limitation of the present application.

FIG. 1 is a schematic structural diagram of a physical server provided by an exemplary embodiment of the present application.

FIG. 2 is a schematic structural diagram of another physical server provided by an exemplary embodiment of the present application.

FIG. 3 is a schematic flowchart of a data processing method provided by an exemplary embodiment of the present application.

### DESCRIPTION OF EMBODIMENTS

In order to make the purpose, technical solutions and advantages of the present application clearer, the technical solutions of the present application will be described clearly and completely in the following in combination with the specific embodiments of the present application and the corresponding accompanying drawings. Obviously, the described embodiments are only a portion of the embodiments of the present application and not all of the embodiments. Based on the embodiments of the present application, all other embodiments obtained by an ordinary person skill in the art without creative effort fall within the protection scope of the present application.

For the problem that the operation of a virtual network card needs to occupy the CPU and memory of the virtual machine, affecting the performance of the virtual machine, and the poor performance of network forwarding implemented based on software, in an embodiment of the present application, for a virtual network card of a virtual machine, on the one hand, a network card acceleration module corresponding to the virtual network card is implemented in the programmable network card device based on programmable hardware, and on the other hand, a service interface component used to implement hardware offloading of the virtual network card is provided in the virtual machine for its upper layer application, so that hardware offloading can be performed on functions of the virtual network card of the virtual machine based on the programmable network card device. Specifically, the upper layer application in the virtual machine configures a forwarding flow table used for the virtual network card into the network card acceleration module through the service interface component, the subsequent data transmission process may be completed by the network card acceleration module based on the forwarding flow table, without or reducing the participation of the virtual network card, which may save CPU resources of the virtual machine, moreover, the data transmission based on hardware may also improve data transmission performance compared to a data transmission method based software.

Technical solutions provided by various embodiments of the present application are described in detail below in conjunction with the accompanying drawings.

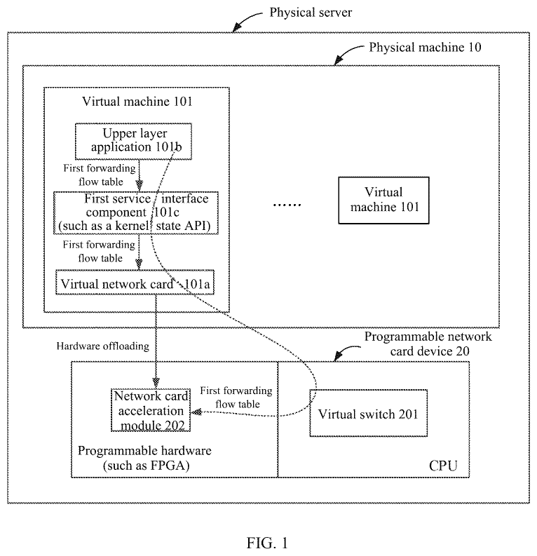

FIG. 1 is a schematic structural diagram of a physical server provided by an exemplary embodiment of the present application. The physical server may be applied in a cloud network system and implemented as an infrastructure in the cloud network system. As shown in FIG. 1, the physical server includes: a physical machine 10, in which at least one virtual machine 101 is deployed, each virtual machine 101 has a virtual network card 101a and an upper layer application 101b, the virtual network card 101a is a network card simulated by the virtual machine 101 to which it belongs through virtualization technology in software or hardware manner, and the virtual network card 101a serves as a network interface of the virtual machine 101 to which it belongs, and used to connect the virtual machine 101 to which it belongs to the network and provide a data transmission service for the upper layer application 101b in the virtual machine 101 to which it belongs.

In addition to the physical machine 101 described above, the physical server in the embodiment of the present application further includes a programmable network card device 20, and the programmable network card device 20 may be implemented as a physical network card of the physical machine 10 and is responsible for forwarding network traffic in the physical machine 101. However, the programmable network card device 20 is no longer solely responsible for forwarding network traffic in the physical machine 101, but may also support hardware offloading of various software functions, which may be implemented as a smart network card (SmartNiC), for example, some operations in the physical machine 10 that need to be executed by the CPU, such as packet encapsulation/decapsulation, network address translation (NAT), speed limiting, really simple syndication (RSS), and so on, may be offloaded to the programmable network card device 20 to be implemented in a hardware manner, which may reduce the burden on the CPU.

Where the programmable network card device 20 is a hardware network card including programmable hardware, for example, the programmable hardware may be an application specific integrated circuit (ASIC), a system on chip (SOC), a field programmable gate array (FPGA), or a complex programmable logic device (CPLD). In addition, the programmable network card device 20 in the embodiment of the present application may be implemented as a pluggable structure, which is plugged into the physical machine 10, and the pluggable method has advantages such as, but not limited to, flexibility of use and strong expandability. For example, the programmable network card device 20 may also be directly integrated on the physical machine 10.

In the embodiment, a virtual switch is deployed on the physical machine 10, and the virtual switch is responsible for data transmission between different virtual machines 101 in the same physical machine 10 and between different virtual machines 101 in different physical machines 10. For example, when a virtual machine E1 and a virtual machine E2 in the same physical machine perform data transmission, the virtual machine E1 first transmits data to the virtual switch through its virtual network card, and the virtual switch forwards the data to the virtual machine E2. For another example, for data transmission between a virtual machine F and a virtual machine G in different physical machines, the virtual machine F transmits data through its virtual network card to a virtual switch in a physical machine to which it belongs, the virtual switch transmits data to a physical network card of the physical machine to which it belongs, the physical network card transmits data to a physical network card of a physical machine to which the virtual machine G belongs, the physical network card transmits data to a virtual switch of the physical machine to which the virtual machine G belongs, and the virtual switch transmits data to the virtual machine G.

In an embodiment of the present application, the virtual switch 201 may be implemented in the programmable network card device 20 with the aid of the hardware offload function of the programmable network card device 20. Where the virtual switch 201 may be implemented in the programmable network card device 20 in a software manner, i.e., the CPU in the programmable network card device 20 may run the program code corresponding to the virtual switch to implement the data forwarding function of the virtual switch.

A process of data transmission of the upper layer application 101b in the virtual machine 101 through the virtual switch 201 is described below in a number of cases. Taking that a virtual machine A0 includes an upper layer application A1 and a virtual network card A2, a physical machine where the virtual machine A0 is located includes a programmable network card device A3, and a virtual switch A4 is implemented in the programmable network card device A3 as an example, the data transmission process of the upper layer application A1 will be explained in the following.

Data forwarding scenario C1: the upper layer application A1 receives a packet from the upper layer application B1 from the other physical machine, processes the packet to a certain extent, and then forwards the processed packet. Specifically, the physical network card in the programmable network card device A3 receives the packet sent by the upper layer application B1 in the other physical machine and provides the packet to the virtual switch A4, the virtual switch A4 provides the packet to the virtual network card A2 in the virtual machine A0, and then the virtual network card A2 provides the packet to upper layer application A1 in virtual machine A0. After processing the packet, the upper layer application A1 provides the processed packet to the virtual network card A2, the virtual network card A2 provides the processed packet to the virtual switch A4, the virtual switch A4 provides the processed packet to the physical network card in the programmable network card device A3, the physical network card in programmable network card device A3 provides the processed packet to the upper layer application B1 through network transmission.

Data sending scenario C2: the upper layer application A1 generates a packet that needs to be sent to an upper layer application in the other virtual machine or to an upper layer application in the other physical machine. The upper layer application A1 will provide the generated packet to the virtual network card A2, and the virtual network card A2 will provide the packet to the virtual switch A4. In a case where the upper layer application A1 instructs to send the packet to the upper layer application in the other virtual machine, the virtual switch A4 provides the packet to the virtual network card of the other virtual machine, and the virtual network card of the other virtual machine provides the packet to the upper layer application in the other virtual machine. In a case where the upper layer application instructs to send the packet to the upper layer application in the other physical machine, the virtual switch A4 provides the packet to the physical network card in the programmable network card device A3, the physical network card in the programmable network card device A3 provides the packet to the physical network card of the other physical machine, for the physical network card of the other physical machine to provide the received packet to the upper layer application of the other physical machine.

Data reception scenario C3: the upper layer application A1 receives a packet sent by upper layer application in the other virtual machine. Specifically, if the virtual machine where the upper layer application A1 is located and the other virtual machine are on the same physical machine, the virtual switch A4 receives the packet sent by the upper layer application in the other virtual machine and provides the packet to the virtual network card A2, the virtual network card A2 provides the received packet to the upper layer application A1 for processing by the upper layer application A1. Or, if the virtual machine where the upper layer application A1 is located and the other virtual machine are located in different physical machines, the physical network card in the programmable network card device A3 receives the packet sent by the upper layer application in the other physical machine and provides the packet to the virtual switch A4, the virtual switch A4 provides the packet to the virtual network card A2, and the virtual network card A2 provides the received packet to the upper layer application A1 for processing by the upper layer application A1.

In the three application scenarios listed above, the virtual switch is implemented using software and is based on a forwarding flow table for data forwarding processing. In addition, the virtual network card is also implemented in software and is based on a forwarding flow table for data sending and receiving processing. In order to facilitate the distinction between the forwarding flow table used by the virtual network card and the forwarding flow table used by the virtual switch, in an embodiments of the present application, the forwarding flow table used by the virtual network card is referred to as a first forwarding flow table, and the forwarding flow table used by the virtual switch is referred to as a second forwarding flow table. Where the virtual network card needs to rely on the CPU of the virtual machine to forward, store, network encrypt and decrypt, or perform security checks on the packet during providing the packet to the upper layer application or receiving the packet from the virtual switch, and the entire process will occupy a large amount of CPU resources of the virtual machine, which affects the performance of the virtual machine. Based on this, in an embodiment of the present application, hardware offloading is performed on functions of the virtual network card 101a of the virtual machine based on the programmable network card device 20, and functions of data sending and receiving, forwarding, and the like that are responsible for the virtual network card 101a are offloaded to the programmable network card device 20 to be performed by the programmable network card device 20, which may reduce the operation performed by the virtual network card 101a, thereby reducing the occupancy of CPU resources of the virtual machine, moreover, the data transmission based on hardware may also improve data transmission performance compared to a data transmission method based software.

In this embodiment, performing hardware offloading on the virtual network card 101a refers to offloading at least some functions of the virtual network card 101a(such as the data transmission function) into the programmable network card device 20 to implement at least some functions of the virtual network card 101a by the hardware in the programmable network card device 20. Where two aspects need to be achieved to perform hardware offloading for the virtual network card 101a, on the one hand, a network card acceleration module corresponding to the virtual network card is implemented in the programmable network card device based on programmable hardware, and on the other hand, a service interface component used to implement hardware offloading of the virtual network card is provided in the virtual machine for its upper layer application, so that hardware offloading can be performed on functions of the virtual network card of the virtual machine based on the programmable network card device. Specifically, the upper layer application in the virtual machine configures a first forwarding flow table used for the virtual network card into the network card acceleration module through the service interface component, the least some of the subsequent data transmission process may be completed by the network card acceleration module based on the first forwarding flow table, without or reducing the participation of the virtual network card, which may save consumptive CPU resources consumed by the operation of the virtual network card, moreover, the data transmission based on hardware may also improve data transmission performance compared to a data transmission method based software.

Specifically, in order to achieve hardware offloading of the functions of the virtual network card 101a, on the one hand, the network card acceleration module 202 is implemented in the programmable network card device based on programmable hardware. Where the programmable hardware in the programmable network card device can be FPGA, CPLD, ASIC, or SOC, etc., the network card acceleration module 202 is implemented using an FPGA, CPLD, ASIC, or SOC, etc. Where one network card acceleration module 202 may be implemented for the virtual network card 101a of each virtual machine 101, or one network card acceleration module 202 may be implemented for the virtual network cards 101a of a plurality of virtual machines 101. The network card acceleration module 202, on the one hand, is used to store the first forwarding flow table used by its corresponding virtual network card, and the first forwarding flow table or the second forwarding flow table is a collection of flow table entries for a particular flow, which maintains a corresponding relationship between packet information and a forwarding rule, and is responsible for searching for the packet and forwarding the packet according to the forwarding rule, and each flow table entry may include, but is not limited to, a head field, a counter, and an action table (Actions). The head field includes most of identifiers of a link layer, a network layer and a transport layer, the counter is used to count data traffic related information such as a flow table, a data flow, a device port, and a forwarding queue, and the action table is used to indicate the next action to be performed. On the other hand, the network card acceleration module 202 also needs to perform data transmission according to the first forwarding flow table instead of the virtual network card corresponding to it.

The first forwarding flow table may be configured to the network card acceleration module 202 by the upper layer application 101b in the virtual machine as needed. For example, the upper layer application may configure the first forwarding flow table to the network card acceleration module 202 during its initialization, or, the upper layer application may dynamically configure the first forwarding flow table to the network card acceleration module 202 according to the application requirement. In order to allow the upper layer application 101b to configure the first forwarding flow table to the network card acceleration module 202, in an embodiment of the present application, the virtual machine 101 provides a first service interface component 101c used to implement hardware offloading of the virtual network card 101a to the upper layer application 101b thereof, and the upper layer application 101b may configure the first forwarding flow table of the virtual network card 101a into the network card acceleration module 202 through the first service interface component 101c and the virtual switch 201. Specifically, the first service interface component 101c is used to intercept the first forwarding flow table provided by the upper layer application 101b and perform data format conversion and/or encapsulation on the first forwarding flow table, and provide the format-converted and/or encapsulated first forwarding flow table to the virtual switch, and configure the first forwarding flow table into the network card acceleration module 202 through the virtual switch 201. Where the implementation manners of the first service interface component 101c vary according to the different development manner of the upper layer application. For example, if the upper layer application is developed based on a data plane development kit (DPDK), the first service interface component may be a user state application program interface (API) provided by DPDK and used to implement hardware offloading of the virtual network card, such as a general flow API (rte_flow) based on the virtual network card of the virtual machine; if the upper layer application is developed based on an operating system of the virtual machine, the first service interface component 101c may be implemented as a kernel state API provided by the operating system and used to implement hardware offloading of the virtual network card, such as a kernel based traffic control (TC) interface.

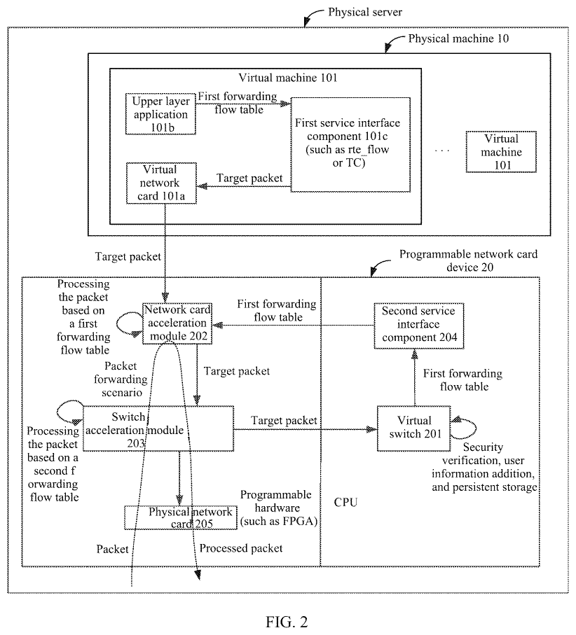

In an embodiment, the process that the upper layer application 101b configures the first forwarding flow table for the virtual network card 101a into the network card acceleration module 202 through the first service interface component 101c and the virtual switch 201 includes: the first service interface component 101c encapsulates the first forwarding flow table provided by the upper layer application 101b as a target packet in response to a call request of the upper layer application 101b, as shown in FIG. 2. Where the target packet may be a packet in a specific format, for example, a default four-tuple/five-tuple/seven-tuple packet, or the target packet may also be a packet with a configuration or offloading tag. After encapsulating the first forwarding flow table as the target packet, the target packet is provided to the virtual switch 201 through the virtual network card 101a. Where, regardless of whether the first service interface component is a user state API or a kernel state API, the first service interface component 101c contains a driver of the virtual network card, the target packet may be provided to the virtual switch 201 via the virtual network card through the first service interface component 101c. A second forwarding flow table is stored in the virtual switch 201, and the second forwarding flow table stores a corresponding relationship between packet information and a forwarding rule, and the virtual switch 201 forwards the packet sent from the virtual network card 101a of the virtual machine or the physical network card of the physical machine implemented in the programmable network card device 20 for processing, based on the second forwarding flow table. In the case that the virtual switch 201 receives the packet, the virtual switch 201 matches the packet to the second forwarding flow table, and in the case that the packet does not match with the second forwarding flow table, i.e., the second forwarding flow table does not store the forwarding rule of the packet, the virtual switch 201 needs to parse the packet for further processing. For the target packet, because the target packet is a specific packet, the second forwarding flow table does not store the forwarding rule corresponding to the target packet, the target packet does not match with the second forwarding flow table, at that point, the virtual switch 201 may parse the target packet, and in the case where the first forwarding flow table is parsed from the target packet, the first forwarding flow table may be configured into the network card acceleration module 202 for the network card acceleration module 202 instead of the virtual network card to perform data transmission based on the first forwarding flow table, the data does not need to be uploaded to the virtual network card for processing in the case of being matched with the first forwarding flow table, which can improve the data transmission speed, and it is equivalent to the network card acceleration module 202 providing the data transmission acceleration service for the virtual network card 101a based on the first forwarding flow table.

Further, in some embodiments of the present application, the hardware offloading of the virtual switch may also be implemented in the programmable network card device 20 with the aid of the hardware offload function of the programmable network card device 20. Specifically, the switch acceleration module 203 implemented based on programmable hardware may be implemented in the programmable network card device 20, where the programmable hardware in the programmable network card device 20 may be FPGA, CPLD, ASIC, or SOC, etc., the switch acceleration module 203 is implemented using an FPGA, CPLD, ASIC, or SOC, etc. The switch acceleration module 203 may provide the data forwarding acceleration service for the virtual switch 201, and the switch acceleration module 203 in the programmable network card device 20 is equivalent to perform hardware offloading on the virtual switch. Where the performing hardware offloading on the virtual network card refers to offloading at least some functions of the virtual network card (such as the data transmission function) into the switch acceleration module 203, for the switch acceleration module 203 instead of the virtual switch to implement the at least some functions, which improves the packet forwarding speed, reduces the participation of the virtual switch, thereby reducing the CPU burden of the programmable network card device 20. Specifically, in the case where the virtual switch 201 is implemented based on software, the second forwarding flow table used by the virtual switch 201 is configured into the switch acceleration module 203, and the switch acceleration module 203 instead of the virtual switch 201 performs the packet forwarding based on the second forwarding flow table, and the packet does not need to be uploaded to the virtual switch 201 for further processing in the case that matching with the second forwarding flow table, which can improve the packet forwarding speed, and it is equivalent to the switch acceleration module 203 providing the data forwarding acceleration service for the virtual switch 201 based on the second forwarding flow table. During the packet sending and receiving process, the packet may first arrive at the switch acceleration module 203, and the switch acceleration module 203 may match with the received packet to the second forwarding flow table. If the data does not match with the second forwarding flow table, i.e., the second forwarding flow table does not contain a flow table entry corresponding to the packet, the packet is provided to the virtual switch for subsequent processing of the packet by the virtual switch. If the packet matches with the second forwarding flow table, i.e., the second forwarding flow table contains a flow table entry corresponding to the packet, the packet may be processed by the switch acceleration module according to the matched flow table entry in the second forwarding flow table, and at this time, the packet does not need to be uploaded to the virtual switch 201 for processing, so that at least some of the subsequent packets may be forwarded and processed directly by the switch acceleration module 203 implemented based on programmable hardware, which may reduce the participation of the virtual switch 201, and further reduce the CPU resources of the programmable network card device 20 that are consumed by the operation of the virtual switch 201, which is helpful for improving the performance of the programmable network card device.

Correspondingly, for the configuration process of the target packet, in the case that the switch acceleration module 203 is implemented by programmable network card device 20 based on programmable hardware, the first service interface component 101c may send the target packet to the switch acceleration module 203 through the virtual network card 101a, and the switch acceleration module 203 matches the target packet to the second forwarding flow table, and in the case where the target packet does not match with the second forwarding flow table, that is, the target packet is a specific packet used to configure the first forwarding flow table of the network card acceleration module, and there is no corresponding flow table entry in the second forwarding flow table, as shown in FIG. 2, the target packet may be uploaded to the virtual switch 201, for the virtual switch 201 to configure the target packet into the network card acceleration module 202.

In an embodiment, the programmable network card device 20 provides a second service interface component 204 towards the virtual switch 201, the second service interface component 204 is a service interface required for the virtual switch 201 to access the network card acceleration module, as shown in FIG. 2. The virtual switch 201 may call the second service interface component 204 to configure the first forwarding flow table into the network card acceleration module 202 through the second service interface component 204. Where the implementation manner of the second service interface component 204 is not limited. The implementation manners of the second service interface component 204 vary according to the different development manner of the virtual switch 201. For example, if the virtual switch 201 is developed based on the DPDK, the second service interface component is a user state API provided based on the DPDK and used to implement flow table configuration, such as rte_flow; and if the virtual switch 201 is developed based on the operating system of the programmable network card device 20, the second service interface component is a kernel state API provided by the operating system and used to implement flow table configuration, such as TC.

In an embodiment, the virtual switch 201 is further configured to perform at least one operation of security verification, user information addition, and persistent storage with respect to the first forwarding flow table, before configuring the first forwarding flow table into the network card acceleration module 202.

The virtual switch 201 may perform security verification and/or interception of illegal operations against the first forwarding flow table at various levels, effectively avoiding the security risk brought about by the virtual machine directly configuring the first forwarding flow table on the network card acceleration module 202. Where the interception of illegal operations is mainly to intercept an illegal parameter submitted by hackers to prevent malicious attacks, or, to intercept some operations that may modify parameters in the programmable network card device, etc. The security verification may include, but are not limited to: the security verification for the upper layer application and the security verification for the first forwarding flow table. The security verification for the upper layer application mainly refers to as security verification for the special character filtering, output filtering, abnormal access detection, own security detection or the like provided by the upper layer application to ensure that the upper layer application is legitimate and secure, and the security verification for the first forwarding flow table mainly refers to verify the timestamp, signature, or key of the first forwarding flow table to ensure that the first forwarding flow table is legitimate and secure.

The switch acceleration module corresponding to the virtual switch 201 may be shared by various virtual machines in the physical machine in which the virtual switch 201 is located, and the virtual switch 201 may receive the first forwarding flow tables issued from different virtual machines, different upper layer applications, or different users, and in order to facilitate the differentiation, the user information may be added to the first forwarding flow tables at the level of the user, virtual machine, or upper layer application, etc., so as to differentiate the first forwarding flow tables of different users, virtual machines, or upper layer applications, to improve the accuracy of packet forwarding, and reduce the error rate. For example, for the first forwarding flow table, the virtual switch 201 may obtain a user identification corresponding to the first forwarding flow table, an identification of the upper layer application to which it belongs, or an identification information of a virtual machine to which it belongs, and add the user identification, the identification information of the virtual machine, or the identification information of the upper layer application to the first forwarding flow table, so as to achieve multi-user sharing of the programmable network card device 20. For some static forwarding flow tables that are more inherent and less susceptible to change, the static forwarding flow table may be stored persistently based on a flow table attribute of the static forwarding flow table, e.g., the static forwarding flow table may be stored in a database or cloud storage system corresponding to the virtual machine, or the static forwarding flow table may be stored in a local storage device of the physical machine or in a database or cloud storage system corresponding to the physical machine, and the static forwarding flow tables may also be stored in a database or local storage device corresponding to the programmable network card device 20. If the static forwarding flow table is lost from the local cache of the switch acceleration device, the lost static forwarding flow table may be loaded from the database or cloud storage system stored persistently, etc., the upper layer application does not need to reconfigure the static forwarding flow table. For some dynamically variable forwarding flow tables, the persistent storage may not be necessary.

In the embodiment, the upper layer application of the virtual machine does not directly issue the first forwarding flow table to the network card acceleration module, but is intercepted by the virtual switch in the programmable network card device, then performs operations such as security verification, user information addition, or persistent storage, and then distribute the first forwarding flow table to the network card acceleration module. At the same time, the virtual switch may also perform persistent storage and interception of illegal operations on the first forwarding flow table, which effectively avoids the security risk brought about by the virtual machine directly operating the network card acceleration module. However, it should be noted that the network card acceleration module may also be directly exposed to the upper layer application of the virtual machine, so that the upper layer application of the virtual machine may also directly issue the first forwarding flow table to the network card acceleration module without going through the virtual switch, which is conducive to improve the distribution efficiency of the flow table.

In the above or following embodiments of the present application, the network card acceleration device, the virtual switch, and the switch acceleration device are implemented in the programmable network card device 20, in an implementation, the programmable network card device 20 further includes a physical network card 205 of a physical machine implemented based on programmable hardware, as shown in FIG. 2. On this basis, different scenarios of data transmission for the physical server are illustrated exemplarily as follows.

Data forwarding scenario M1: the virtual machine J receives the data sent by the virtual machine K, and after processing the data, forwards the processed data to the virtual machine H. If the virtual machine J is located in the same physical server as the virtual machine K, the virtual machine K provides the first packet to a switch acceleration module on the same physical server through its virtual network card; the switch acceleration module matches the first packet to the second forwarding flow table, and in the case that matching with the flow table entry corresponding to the virtual machine J, sends the first packet to the network card acceleration module corresponding to the virtual machine J. If the virtual machine J and the virtual machine K are located in different physical servers, the virtual machine K provides the first packet to a switch acceleration module in a physical server to which it belongs through its virtual network card; the switch acceleration module matches the first packet to the second forwarding flow table, and in the case that matching with the flow table entry corresponding to the physical server to which the virtual machine J belongs, sends the first packet to the physical network card of the physical server to which the virtual machine K belongs, for the physical network card to provide the first packet to the physical network card of the physical server to which the virtual machine J belongs through network transmission, and the physical network card provides the first packet to the switch acceleration device of the physical server to which the virtual machine J belongs.

Regardless of whether the virtual machine J and the virtual machine K are located on the same physical server, the switch acceleration module of the physical server to which the virtual machine J belongs receives the first packet, matches the first packet to the second forwarding flow table, and in the case that matching with the flow table entry corresponding to the virtual machine J, provides the first packet to the network card acceleration module corresponding to the virtual machine J, the network card acceleration module processes the first packet based on the first forwarding flow table to obtain the processed first packet, and sends the processed first packet to the switch acceleration module on the physical server to which the virtual machine J belongs, and the switch acceleration module forwards the processed first packet based on the second forwarding flow table.

If the virtual machine J and the virtual machine H are located in the same physical server, the switch acceleration module in the physical server to which the virtual machine J or the virtual machine H belongs provides the processed first packet to the network card acceleration module corresponding to the virtual machine H based on the second forwarding flow table, and the network card acceleration module processes the processed first packet based on the first forwarding flow table. If the virtual machine J and the virtual machine H are located in different physical servers, the switch acceleration module in the physical server to which the virtual machine J belongs provides the processed first packet to the physical network card of the physical server to which the virtual machine J belongs based on the second forwarding flow table, the physical network card forwards the processed first packet to the physical network card of the physical server to which the virtual machine H belongs, and the physical network card of the physical server to which the virtual machine H belongs provides the processed first packet to the switch acceleration device of the physical server to which the virtual machine H belongs, and the switch acceleration device provides the processed first packet to the network card acceleration device corresponding to the virtual machine H based on the second forwarding flow table, and the network card acceleration device processes the processed first packet based on the first forwarding flow table. It should be noted that the second forwarding flow tables used by switch acceleration modules on different physical servers are generally different, and similarly, the first forwarding flow tables used by the network card acceleration modules corresponding to different virtual machines are also generally different.

Data sending scenario M2: the upper layer application in the virtual machine S provides the second packet that it generates to the virtual machine T. The upper layer application in the virtual machine S provides the second packet to the network card acceleration device corresponding to the virtual machine A through the virtual network card, and the network card acceleration device processes the second packet based on the first forwarding flow table, obtains the processed second packet, and sends the processed second packet to the switch acceleration module in the physical server to which the virtual machine S belongs, and the switch acceleration module forwards the processed second packet to the virtual machine T based on the second forwarding flow table.

If the virtual machine S and the virtual machine T are located in the same physical server, the switch acceleration module in the physical server to which the virtual machine S belongs provides the processed second packet to the network card acceleration module corresponding to the virtual machine T based on the second forwarding flow table, and the network card acceleration module processes the processed second packet based on the first forwarding flow table. If the virtual machine S and the virtual machine T are located in different physical servers, the switch acceleration module in the physical server to which the virtual machine S belongs provides the processed second packet to the physical network card of the physical server to which the virtual machine S belongs based on the second forwarding flow table, the physical network card forwards the processed second packet to the physical network card of the physical server to which the virtual machine T belongs via network transmission, the physical network card of the physical server to which the virtual machine T belongs provides the processed second packet to the switch acceleration device of the physical server to which the virtual machine T belongs, the switch acceleration device provides the processed second packet to the network card acceleration device corresponding to the virtual machine T based on the second forwarding flow table, and the network card acceleration device processes the processed second packet based on the first forwarding flow table.

Data reception scenario M3: the virtual machine X receives the third packet generated by the upper layer application in the virtual machine Y. If the virtual machine X and the virtual machine Y are located in the same physical server, the virtual machine Y sends the third packet generated by the upper layer application in virtual machine Y to the switch acceleration module in the physical server to which the virtual machine Y belongs through the virtual network card. If the virtual machine X is located on different physical server from the virtual machine Ys, the virtual machine Y provides the third packet to the switch acceleration module in the physical server to which the virtual machine Y belongs through the virtual network card, the switch acceleration module sends the third packet to the physical network card on the physical server to which it belongs based on the second forwarding flow table, and the physical network card provides the third packet to the physical network card of the physical server to which the virtual machine X belongs via network transmission, and the physical network card provides the third packet to the switch acceleration module of the physical server to which the virtual machine X belongs.

Regardless of whether the virtual machine X and the virtual machine Y are located in the same physical server, the switch acceleration module of the physical server to which the virtual machine X belongs provides the third packet based on the second forwarding flow table to the network card acceleration module corresponding to the virtual machine X, where the network card acceleration module processes the third packet based on the first forwarding flow table.

In the above data sending and receiving scenarios, in the case where the switch acceleration module is unable to match with the second forwarding flow table, the corresponding packets (e.g., the first, second, or third packets) may be uploaded to the virtual switch corresponding to the switch acceleration module for processing; similarly, in the case where the network card acceleration module is unable to match with the first forwarding flow table, the corresponding packets (e.g., the first, second, or third packets) may be uploaded to the virtual network card corresponding to the network card acceleration module for processing.

In addition to the physical server mentioned above, an embodiment of the present application further provides a programmable network card device, as shown in FIG. 2, the programmable network card device 20 includes: a network card acceleration module 202 implemented based on programmable hardware, the network card acceleration module 202 corresponds to one virtual network card and may achieve hardware offloading of the functions of the virtual network card. Specifically, the network card acceleration module 202 is configured with a first forwarding flow table used by the virtual network card, based on which the network card acceleration module 202 may provide a data transmission acceleration service for the virtual network card based on the first forwarding flow table, thereby achieving hardware offloading of the functions of the virtual network card.

Further, as shown in FIG. 2, the programmable network card device 20 may further include, in addition to the network card acceleration module 202 implemented based on programmable hardware: a virtual switch 201 configured to perform data forwarding between different virtual machines, where the virtual switch 21 is configured to cooperate with a first service interface component in a virtual machine to which the virtual network card belongs to configure the first forwarding flow table used for the virtual network card into the network card acceleration module. The first service interface component is a service interface component provided by the virtual machine to an upper layer application of the virtual machine and used to implement hardware offloading of the virtual network card. After the virtual switch 201 configures the first forwarding flow table used by the virtual network card into the network card acceleration module 202, the network card acceleration module 202 may provide the data transmission acceleration service for that virtual network card based on the first forwarding flow table. It should be noted that the programmable network card device provided by an embodiment of the present application may be applied to a physical machine contained in a physical server, where at least one virtual machine is deployed on the physical machine, and each virtual machine has a respective virtual network card, and the network card acceleration module 202 may be implemented in the programmable network card device with respect to the virtual network card of each virtual machine, which has the same specific realization process and will not be elaborated one by one.

In an embodiment, the virtual switch 201 is configured to: receive a target packet provided by the first service interface component through the virtual network card, the target packet is obtained by the first service interface component thought encapsulating the first forwarding flow table provided by the upper layer application in response to a call request of the upper layer application; and parse the first forwarding flow table from the target packet in a case where the target packet does not match with a second forwarding flow table, and configure the forwarding flow table into the network card acceleration module, for the network card acceleration module to provide the data transmission acceleration service for the virtual network card based on the first forwarding flow table, the second forwarding flow table is a forwarding flow table used by the virtual switch.

In an embodiment, the programmable network card device further includes: a switch acceleration module implemented based on programmable hardware; the switch acceleration module is configured to provide a data forwarding acceleration service for the virtual switch based on the second forwarding flow table configured in the virtual switch. Based on this, the first service interface component is specifically configured to send the target packet to the switch acceleration module through the virtual network card; accordingly, when receiving the target packet provided by the first service interface component through the virtual network card, the virtual switch is specifically configured to: receive the target packet reported by the switch acceleration module in a case where the target packet does not match with the second forwarding flow table.

In an embodiment, when configuring the first forwarding flow table into the network card acceleration module, the virtual switch is specifically configured to: call a second service interface component, and configure the first forwarding flow table into the network card acceleration module, where the second service interface component is a service interface required for the virtual switch to access the network card acceleration module.

In an embodiment, the virtual switch is further configured to perform at least one operation of security verification, user information addition, and persistent storage with respect to the first forwarding flow table, before configuring the first forwarding flow table into the network card acceleration module.

In an embodiment, the virtual switch is developed based on the DPDK, and the second service interface component is a user state API provided based on DPDK and used to implement flow table configuration. Correspondingly, the upper layer application is developed based on the DPDK, the second service interface component is a user state API provided based on the DPDK and used to implement flow table configuration, or, the upper layer application is developed based on an operating system, the second service interface component is a kernel state API provided by the operating system and used to implement flow table configuration.

In an embodiment, when providing the data transmission acceleration service for the virtual network card based on the first forwarding flow table, the network card acceleration module is specifically configured to: receive a first packet sent by the switch acceleration module in a physical server to which it belongs that requires forwarding processing by the upper layer application, process the first packet based on the first forwarding flow table to obtain a processed first packet, and send the processed first packet to the switch acceleration module, for the switch acceleration module to forward the processed first packet based on the second forwarding flow table; or, receive a second packet sent by the upper layer application through the virtual network card, process the second packet based on the first forwarding flow table to obtain the processed second packet, and send the processed second packet to the switch acceleration module in the physical server to which it belongs, for the switch acceleration module to forward the processed second packet based on the second forwarding flow table; or, receive a third packet sent by the switch acceleration module in a physical server to which it belongs that requires reception processing by the upper layer application, process the third packet based on the first forwarding flow table to obtain the processed third packet, and report the processed third packet through the virtual network card to the upper layer application for reception processing.

In an embodiment, the programmable network card device further includes a physical network card of the physical machine implemented based on programmable hardware, and the switch acceleration module is further configured to: receive a packet sent by the physical network card from the other physical machine and forward the packet, or provide the physical network card with a packet that requires to be sent to the other physical machine, for the physical network card to forward the packet.

The programmable network card device provided by an embodiment of the present application performs hardware offloading on the virtual network card of the virtual machine based on the programmable network card device, which mainly includes two aspects, on the one hand, a network card acceleration module implemented in the programmable network card device based on programmable hardware, and on the other hand, a service interface component provided by the virtual machine to its upper layer application for implementing hardware offloading of the virtual network card. The upper layer application may configure a forwarding flow table used for the virtual network card into the network card acceleration module through the service interface component and the virtual switch, at least some of the subsequent data transmission process may be completed by the network card acceleration module instead of the virtual network card based on the forwarding flow table, without or reducing the participation of the virtual network card, which saves CPU resources of the virtual machine, and improves data transmission performance of the virtual machine.

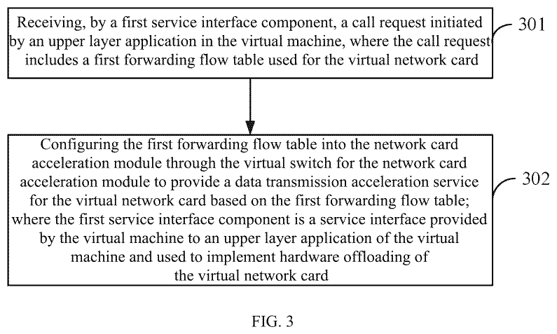

FIG. 3 is a schematic flowchart of a data processing method provided by an exemplary embodiment of the present application. The data processing method is applied to a physical server, where the physical server includes a physical machine, a virtual machine is deployed in the physical machine, and the virtual machine has a virtual network card, the physical server further includes a programmable network card device, the programmable network card device includes a network card acceleration module implemented based on programmable hardware, and a virtual switch configured to perform data forwarding between different virtual machines, and a detailed introduction of the various components in the physical server may be found in the foregoing embodiments, and will not be further described herein. The method provided by this embodiment is described from a perspective of the first service interface component, as shown in FIG. 3, the method includes:
301: receiving, by a first service interface component, a call request initiated by an upper layer application in the virtual machine, where the call request includes a first forwarding flow table used for the virtual network card;
302: configuring the first forwarding flow table into the network card acceleration module through the virtual switch, for the network card acceleration module to provide a data transmission acceleration service for the virtual network card based on the first forwarding flow table; where the first service interface component is a service interface provided by the virtual machine to an upper layer application of the virtual machine and used to implement hardware offloading of the virtual network card.

In an embodiment, the receiving, by the first service interface component, the call request initiated by the upper layer application in the virtual machine, and configuring the first forwarding flow table into the network card acceleration module through the virtual switch includes: encapsulating, by the first service interface component, the first forwarding flow table provided by the upper layer application as a target packet in response to the call request of the upper layer application, and sending the target packet to the virtual switch in a case where the target packet does not match with a second forwarding flow table, for the virtual switch to parse the first forwarding flow table from the target packet and configure the first forwarding flow table into the network card acceleration module; where the second forwarding flow table is a forwarding flow table used by the virtual switch.

In an embodiment, the programmable network card device further includes: a switch acceleration module implemented based on programmable hardware, configured to provide a data forwarding acceleration service for the virtual switch based on the second forwarding flow table configured in the virtual switch; and the sending the target packet to the virtual switch in a case where the target packet does not match with the second forwarding flow table includes: sending the target packet to the switch acceleration module through the virtual network card for the switch acceleration module to report the target packet to the virtual switch in a case where the target packet does not match with the second forwarding flow table.

In an embodiment, the configuring the first forwarding flow table into the network card acceleration module includes: calling a second service interface component, and configuring the first forwarding flow table into the network card acceleration module, where the second service interface component is a service interface required for the virtual switch to access the network card acceleration module.

In an embodiment, the method provided by an embodiment of the present application further includes: performing, by the virtual switch, at least one operation of security verification, user information addition, and persistent storage with respect to the first forwarding flow table, before configuring the first forwarding flow table into the network card acceleration module.

In an embodiment, the providing the data transmission acceleration service for the virtual network card based on the first forwarding flow table includes: receiving, by the network card acceleration module, a first packet sent by the switch acceleration module that requires forwarding processing by the upper layer application, processing the first packet based on the first forwarding flow table to obtain a processed first packet, and sending the processed first packet to the switch acceleration module, for the switch acceleration module to the processed first packet based on the second forwarding flow table; or, receiving, by the network card acceleration module, a second packet sent by the upper layer application through the virtual network card, processing the second packet based on the first forwarding flow table to obtain the processed second packet, and sending the processed second packet to the switch acceleration module, for the switch acceleration module to forward the processed second packet based on the second forwarding flow table; or, receiving, by the network card acceleration module, a third packet sent by the switch acceleration module that requires reception processing by the upper layer application, processing, the third packet based on the first forwarding flow table to obtain the processed third packet, and reporting the processed third packet through the virtual network card to the upper layer application for reception processing.

In an embodiment, the programmable network card device further includes a physical network card implemented of the physical machine based on programmable hardware, and the method provided by an embodiment of the present application further includes: receiving, by the switch acceleration module, a packet sent by the physical network card from the other physical machine and forwarding the packet, or providing the physical network card with a packet that requires to be sent to the other physical machine, for the physical network card to forward the packet.

In an embodiment, where the upper layer application is developed based on an operating system of the virtual machine, and the first service interface component is a kernel state API provided by the operating system and used to implement hardware offloading of the virtual network card; or, the upper layer application is developed based on DPDK, and the first service interface component is a user state API provided based on DPDK and used to implement hardware offloading of the virtual network card.

In the data processing method provided by an embodiment of the present application, for a virtual network card of a virtual machine, on the one hand, a network card acceleration module corresponding to the virtual network card is implemented in the programmable network card device based on programmable hardware, and on the other hand, a service interface component used to implement hardware offloading of the virtual network card is provided in the virtual machine for its upper layer application, so that hardware offloading can be performed on functions of the virtual network card of the virtual machine based on the programmable network card device. Specifically, the upper layer application in the virtual machine configures a forwarding flow table used for the virtual network card into the network card acceleration module through the service interface component, at least some of the subsequent data transmission process may be completed by the network card acceleration module instead of the virtual network card based on the forwarding flow table, without or reducing the participation of the virtual network card, which may save CPU resources of the virtual machine, moreover, the data transmission based on hardware may also improve data transmission performance compared to a data transmission method based software.

It should be noted that an executive subject of steps of each method provided in the above embodiments may be the same device, or, alternatively, the method is also executed by different devices as the executive subjects. For example, an executive subject of steps 301 to 302 may be a device A; or, for example, an executive subject of step 301 may be the device A and an executive subject of step 302 may be a device B. and so on.

In addition, in some of the processes described in the above embodiments and accompanying drawings, a plurality of operations that appear in a specific order are included, but it should be clearly understood that these operations may be performed in any order other than the order in which they appear herein, or performed in parallel, and that serial numbers of the operations, such as 301, 302, and the like, are merely used to distinguish the various different operations from each other, and the serial numbers themselves do not represent any execution order. In addition, these processes can include more or fewer operations, and these operations may be performed sequentially or in parallel. It should be noted that the descriptions of “first” and “second” herein are used to distinguish between different messages, devices, modules, etc., and do not represent an order of precedence, nor do they limit the “first” and “second” to be of different types.

In the embodiment, the physical server includes, in addition to the components described above, other components such as: a memory, a processor, a communication component, and a power supply component, which are not shown in FIG. 1 and FIG. 2.

The memory is used to store a computer program and may be configured to store various other data to support operations in the physical server. Examples of such data include instructions for any application or method operated in the physical server.

The memory may be implemented by any type of volatile or non-volatile storage devices or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk.

Accordingly, an embodiment of the present application also provides a computer readable storage medium storing a computer program, the computer program, when executed by a processor, causes the processor to implement the steps in the method shown in FIG. 3.

Accordingly, an embodiment of the present application also provides a computer program product including a computer program/instructions, where the computer program/the instructions, when executed by a processor, cause the processor to implement the steps in the method shown in FIG. 3.

The communication component described above is configured to facilitate communication by wired or wireless means between the device in which the communication component is located and other devices. The device in which the communication component is located may access a wireless network based on a communication standard such as WiFi, a mobile communication network such as 2G, 3G, 4G/LTE, 5G, or a combination thereof. In an exemplary embodiment, the communication component receives a broadcast signal or broadcast related information from an external broadcast management system through a broadcast channel. In an exemplary embodiment, the communication component further includes a near field communication (NFC) module to facilitate short-range communication. For example, the NFC module may be implemented based on a radio frequency identification (RFID) technology, an infrared data association (IrDA) technology, an ultra wideband (UWB) technology, a bluetooth (BT) technology, and other technologies.

The above power component provides power to various components of the device where the power component is located. The power component may include a power management system, one or more power sources, and other components associated with generating, managing, and distributing power to the device where the power component is located.

It should be understood by those skilled in the art that embodiments of the present application may be provided as a method, a system, or a computer program product. Therefore, the present application may take a form of a complete hardware embodiment, a complete software embodiment, or a combination of software and hardware embodiments. Moreover, the present application may take a form of a computer program product implemented in one or more computer-usable storage media (including but not limited to a magnetic disk memory, a CD-ROM, an optical memory, etc.) containing a computer-usable program code.

The embodiments of the present application are described with reference to flow charts and/or block diagrams of methods, devices (systems) and computer program products according to the embodiments of the present application. It will be appreciated that computer program instructions can implement each flow and/or block in the flow charts and/or the block diagrams, and a combination of a flow and/or a block in the flow charts and/or the block diagrams. These computer program instructions may be provided to a processor of a general purpose computer, a special purpose computer, an embedded processor or other programmable data processing devices to generate a machine, so that instructions executed by the processor of the computers or other programmable data processing devices generate a device for implementing functions specified in one or more flows of the flow charts and/or one or more blocks of the block diagrams.

These processor program instructions may also be stored in a computer-readable memory capable of directing the computers or other programmable data processing devices to operate in a specific manner, so that instructions stored in the computer-readable memory generate a manufactured product including an instruction device, where the instruction device implements functions specified in one or more flows of the flow charts and/or one or more blocks of the block diagrams.

These computer program instructions may also be loaded in the computers or other programmable data processing devices, so that a series of operation steps are performed in the computers or other programmable devices to generate a computer-implemented process, and thus the instructions executed in the computers or other programmable devices provide steps for implementing the functions specified in one or more flows of the flow charts and/or one or more blocks of the block diagrams.

In a typical configuration, a computing device includes one or more processors (CPU), an input/output interface, a network interface, and a memory. The memory may include forms of a non-permanent memory, a random access memory (RAM), and/or a non-volatile memory in a computer-readable medium, etc., such as a read-only memory (ROM) or a flash memory (flash RAM). The memory is an example of a computer readable medium.

The computer readable medium, including a permanent and non-permanent, removable and non-removable medium, may be used by any method or technology to implement information storage. Information may be a computer readable instruction, a data structure, a procedural module, or other data. Examples of storage medium for computers include, but are not limited to, a phase change random access memory (PRAM), a static random access memory (SRAM), a dynamic random access memory (DRAM), other types of random access memories (RAM), a read-only memory (ROM), an electrically erasable programmable read-only memory (EEPROM), a flash memory or other memory technologies, a read-only optical disc read-only memory (CD-ROM), a digital multifunctional digital video disk (DVD) or other optical storage, a magnetic cassette tape, a magnetic tape and magnetic disk storage or other magnetic storage devices, or any other non-transmission medium that may be used to store information that may be accessed by the computing device. According to the definition herein, the computer readable medium does not include a transitory computer readable medium (transitory media), such as a modulated data signal and a carrier.

It should also be noted that the terms “comprise”, “include”, or any other variation thereof are intended to encompass non-exclusive inclusion, such that a process, a method, a commodity, or a device including a series of elements not only includes those elements, but also other elements that are not explicitly listed, or also includes elements inherent to such the process, the method, the commodity, or the device. Without further limitation, an element defined by the phrase “including a . . . ” does not exclude the existence of other identical elements in the process, the method, the commodity or the device including the element.

The above are only embodiments of the present application and are not intended to limit the present application. Various modifications and variations of the present application are possible for those skilled in the art. Any modifications, equivalent replacements, improvements, etc. made within the spirit and principle of the present application shall be included within the scope of the claims of the present application.

1. A physical server, comprising: a physical machine, wherein a virtual machine is deployed in the physical machine, and the virtual machine comprises a virtual network card configured to provide a data transmission service for an upper layer application in the virtual machine; the physical server further comprises a programmable network card device, in which a virtual switch is implemented for data forwarding between different virtual machines;
wherein the programmable network card device further comprises a network card acceleration module implemented based on programmable hardware, and the virtual machine is further configured to provide a first service interface component for implementing hardware offloading of the virtual network card to the upper layer application of the virtual machine, for the upper layer application to configure, through the first service interface component and the virtual switch, a first forwarding flow table used for the virtual network card into the network card acceleration module;
the network card acceleration module is configured to provide a data transmission acceleration service for the virtual network card based on the first forwarding flow table.

2. The physical server according to claim 1, wherein the first service interface component is configured to: encapsulate the first forwarding flow table provided by the upper layer application as a target packet in response to a call request of the upper layer application, and provide the target packet to the virtual switch through the virtual network card;
the virtual switch is configured to parse the first forwarding flow table from the target packet in a case where the target packet does not match with a second forwarding flow table, and configure the first forwarding flow table into the network card acceleration module, for the network card acceleration module to provide the data transmission acceleration service for the virtual network card based on the first forwarding flow table, wherein the second forwarding flow table is a forwarding flow table used by the virtual switch.

3. The physical server according to claim 2, wherein the programmable network card device further comprises: a switch acceleration module implemented based on programmable hardware, configured to provide a data forwarding acceleration service for the virtual switch based on the second forwarding flow table configured in the virtual switch;
when providing the target packet to the virtual switch through the virtual network card, the first service interface component is specifically configured to: send the target packet to the switch acceleration module through the virtual network card, to enable the switch acceleration module to report the target packet to the virtual switch in a case where the target packet does not match with the second forwarding flow table.

4. The physical server according to claim 2, wherein when configuring the first forwarding flow table into the network card acceleration module, the virtual switch is specifically configured to: call a second service interface component, and configure the first forwarding flow table into the network card acceleration module, wherein the second service interface component is a service interface required for the virtual switch to access the network card acceleration module.

5. The physical server according to claim 4, wherein the virtual switch is further configured to perform at least one operation of security verification, user information addition, and persistent storage with respect to the first forwarding flow table, before configuring the first forwarding flow table into the network card acceleration module.

6. The physical server according to claim 4, wherein the virtual switch is developed based on a data plane development kit (DPDK), and the second service interface component is a user state application program interface (API) provided based on DPDK and used to implement flow table configuration.

7. The physical server according to claim 3, wherein when providing the data transmission acceleration service for the virtual network card based on the first forwarding flow table, the network card acceleration module is specifically configured to:
receive a first packet sent by the switch acceleration module that requires forwarding processing by the upper layer application, process the first packet based on the first forwarding flow table to obtain a processed first packet, and send the processed first packet to the switch acceleration module, for the switch acceleration module to forward the processed first packet based on the second forwarding flow table; or,
receive a second packet sent by the upper layer application through the virtual network card, process the second packet based on the first forwarding flow table to obtain the processed second packet, and send the processed second packet to the switch acceleration module, for the switch acceleration module to forward the processed second packet based on the second forwarding flow table; or,
receive a third packet sent by the switch acceleration module that requires reception processing by the upper layer application, process the third packet based on the first forwarding flow table to obtain the processed third packet, and report the processed third packet through the virtual network card to the upper layer application for reception processing.

8. The physical server according to claim 3, wherein the programmable network card device further comprises a physical network card of the physical machine implemented based on programmable hardware, and the switch acceleration module is further configured to: receive a packet sent by the physical network card from the other physical machine and forward the packet, or provide the physical network card with a packet that requires to be sent to the other physical machine, for the physical network card to forward the packet.

9. The physical server according to claim 1, wherein the upper layer application is developed based on an operating system of the virtual machine, and the first service interface component is a kernel state API provided by the operating system and used to implement hardware offloading of the virtual network card; or,
the upper layer application is developed based on a data plane development kit DPDK, and the first service interface component is a user state API provided based on DPDK and used to implement hardware offloading of the virtual network card.

10. A programmable network card device, wherein the programmable network card device comprises: a network card acceleration module implemented based on programmable hardware, the network card acceleration module corresponds to one virtual network card;
the network card acceleration module is configured with a first forwarding flow table used by the virtual network card, and configured to provide a data transmission acceleration service for the virtual network card based on the first forwarding flow table.

11. The device according to claim 10, wherein the programmable network card device further comprises: a virtual switch configured to perform data forwarding between different virtual machines;
the virtual switch is configured to cooperate with a first service interface component on a virtual machine to which the virtual network card belongs, to configure the first forwarding flow table used for the virtual network card into the network card acceleration module; the first service interface component is a service interface component provided by the virtual machine to an upper layer application of the virtual machine and used to implement hardware offloading of the virtual network card.

12. The device according to claim 11, wherein the virtual switch is specifically configured to: receive a target packet provided by the first service interface component through the virtual network card, the target packet is obtained by the first service interface component thought encapsulating the first forwarding flow table provided by the upper layer application in response to a call request of the upper layer application; and parse the first forwarding flow table from the target packet in a case where the target packet does not match with a second forwarding flow table, and configure the forwarding flow table into the network card acceleration module, for the network card acceleration module to provide the data transmission acceleration service for the virtual network card based on the first forwarding flow table, the second forwarding flow table is a forwarding flow table used by the virtual switch.

13. The device according to claim 12, wherein the programmable network card device further comprises: a switch acceleration module implemented based on programmable hardware;
the switch acceleration module is configured to provide a data forwarding acceleration service for the virtual switch based on the second forwarding flow table configured in the virtual switch;
when receiving the target packet provided by the first service interface component through the virtual network card, the virtual switch is specifically configured to: receive the target packet reported by the switch acceleration module in a case where the target packet does not match with the second forwarding flow table.

14. A data processing method, applied to a physical server, wherein the physical server comprises a physical machine, a virtual machine is deployed in the physical machine, and the virtual machine comprises a virtual network card, wherein the physical server further comprises a programmable network card device, the programmable network card device comprises a network card acceleration module implemented based on programmable hardware, and a virtual switch configured to perform data forwarding between different virtual machines, and the method comprises:
receiving, by a first service interface component, a call request initiated by an upper layer application in the virtual machine, wherein the call request comprises a first forwarding flow table used for the virtual network card, and configuring the first forwarding flow table into the network card acceleration module through the virtual switch, for the network card acceleration module to provide a data transmission acceleration service for the virtual network card based on the first forwarding flow table; wherein the first service interface component is a service interface provided by the virtual machine to an upper layer application of the virtual machine and used to implement hardware offloading of the virtual network card.

15. The method according to claim 14, wherein the receiving, by the first service interface component, the call request initiated by the upper layer application in the virtual machine, and configuring the first forwarding flow table into the network card acceleration module through the virtual switch comprises:
encapsulating, by the first service interface component, the first forwarding flow table provided by the upper layer application as a target packet in response to the call request of the upper layer application, and sending the target packet to the virtual switch in a case where the target packet does not match with a second forwarding flow table, for the virtual switch to parse the first forwarding flow table from the target packet and configure the first forwarding flow table into the network card acceleration module; wherein the second forwarding flow table is a forwarding flow table used by the virtual switch.

16. The method according to claim 15, wherein the programmable network card device further comprises: a switch acceleration module implemented based on programmable hardware, configured to provide a data forwarding acceleration service for the virtual switch based on the second forwarding flow table configured in the virtual switch;
the sending the target packet to the virtual switch in a case where the target packet does not match with the second forwarding flow table comprises: sending the target packet to the switch acceleration module through the virtual network card for the switch acceleration module to report the target packet to the virtual switch in a case where the target packet does not match with the second forwarding flow table.

17. The method according to claim 16, wherein the providing the data transmission acceleration service for the virtual network card based on the first forwarding flow table comprises:
receiving, by the network card acceleration module, a first packet sent by the switch acceleration module that requires forwarding processing by the upper layer application, processing the first packet based on the first forwarding flow table to obtain a processed first packet, and sending the processed first packet to the switch acceleration module, for the switch acceleration module to the processed first packet based on the second forwarding flow table; or,
receiving, by the network card acceleration module, a second packet sent by the upper layer application through the virtual network card, processing the second packet based on the first forwarding flow table to obtain the processed second packet, and sending the processed second packet to the switch acceleration module, for the switch acceleration module to forward the processed second packet based on the second forwarding flow table; or,
receiving, by the network card acceleration module, a third packet sent by the switch acceleration module that requires reception processing by the upper layer application, processing, the third packet based on the first forwarding flow table to obtain the processed third packet, and reporting the processed third packet through the virtual network card to the upper layer application for reception processing.

18. A non-transitory computer readable storage medium storing a computer program, wherein the computer program, when executed by a processor, causes the processor to implement steps in the method according to claim 14.

19. (canceled)

20. The physical server according to claim 2, wherein the programmable network card device further comprises a physical network card of the physical machine implemented based on programmable hardware, and a switch acceleration module that is configured to: receive a packet sent by the physical network card from the other physical machine and forward the packet, or provide the physical network card with a packet that requires to be sent to the other physical machine, for the physical network card to forward the packet.

21. The physical server according to claim 3, wherein the programmable network card device further comprises a physical network card of the physical machine implemented based on programmable hardware, and the switch acceleration module is further configured to: receive a packet sent by the physical network card from the other physical machine and forward the packet, or provide the physical network card with a packet that requires to be sent to the other physical machine, for the physical network card to forward the packet.
